(19) United States
(12) Patent Application Publication
(10) Pub. No.: US 2014/0000762 A1
(43) Pub. Date: Jan. 2, 2014

(54) Process and Device for Producing Parts, Notably Elongated Revolving Parts, by Machining a Bar Held Fixed in Rotation

(71) Applicants: Christian Fromholz, Montigny-les-Metz (FR); Laurent Berviller, Maizieres Les Metz (FR); Philippe Roser, Weislingen (FR)

(72) Inventors: Christian Fromholz, Montigny-les-Metz (FR); Laurent Berviller, Maizieres Les Metz (FR); Philippe Roser, Weislingen (FR)

(73) Assignee: SIIMO, Montigny-les-Metz (FR)

(21) Appl. No.: 14/005,355

(22) PCT Filed: Mar. 15, 2012
(86) PCT No.: PCT/FR12/50538

§ 371 Date: Sep. 16, 2013

(30) Foreign Application Priority Data
Mar. 18, 2011 (FR) 1152237

(51) Int. Cl. B27C 7/00; B27C 5/08

(52) U.S. Cl. CPC B27C 7/005; B27C 5/08
USPC 144/365; 82/130

(57) ABSTRACT

The bar is machined, according to a required longitudinal and/or circumferential profile, by rotating tools carried by a main plate driven in rotation on the frame, the tools being connected to the plate by tool supports radially mobile on this plate, and depending on the required profile, a radial movement of the tool supports is controlled according to the axial position of the bar in relation to the chassis and/or the circumferential positions of the tools in relation to the bar. To control the radial movement, a secondary plate is driven in rotation coaxially to the main plate. The secondary plate including a device for actuating tool supports, arranged so that the positions of the tool supports depend on the relative angular position between the main plate and the secondary plate and, to permanently adjust the radial positioning of the tools during the rotation of the main plate, the relative angular position is modified.

### FIELD OF THE INVENTION

The present invention relates to a new process and a new device for producing parts, notably elongated revolving parts of variable section in the longitudinal direction, by machining a bar held fixed in rotation.

Below, revolving parts means all parts of circular section, but also parts of a general elliptical shaped section or even, for certain possible applications, of general polygonal shape or, again, twisted parts, etc.

Machining means generally all manufacturing processes by the removal of material by cutting tools, abrasives, etc.

The aim of the invention is notably, but not exclusively, the production of wooden parts elongated in a main axial direction, in particular axisymmetrical parts, from long wooden bars. It can also apply to the production of parts made of other materials, notably plastic, synthetic materials. The invention applies particularly to the production, from a long bar, of parts with small sections in relation to their lengths. It also applies to the production of more bulky parts by a transformation by machining of a bar with a typically substantially square section, of any length, straight or curved, into parts of axisymmetrical section: circular, oval, square, possibly helicoidal, etc. of variable longitudinal profile and respectively straight or curved.

### BACKGROUND

Processes and production machines, based on the principle of turning a tool or tools around the machined part which remains fixed in rotation, are already known.

A process and a device are already known from WO2010/046570, for producing revolving parts, or of general similar shape, notably wooden parts, elongated and of variable section in the longitudinal direction, allowing the machining, from straight or curved bars of any length held fixed in rotation, of parts of sections both circular and of any axisymmetrical shape, and according to a given longitudinal profile. This machining device also allows, among other things, the machining of heavy and bulky parts such as profiled bars, beam posts and similar, obtained from bars made of machinable materials, such as hard or soft wood, or other materials.

The device includes a fixed chassis carrying guide means to guide said bar in translation along a main axis and to hold it fixed in rotation, and a rotating assembly driven in rotation in relation to the chassis along the main axis. The rotating assembly includes a plate and at least two rotating tools supported by arms pivoting in relation to the plate in a plane orthogonal to the main axis. The tools are driven in rotation along respective axes of rotation substantially parallel to the main axis. Means for controlling the positions of the pivoting arms are provided to adjust the radial positioning of the tools in relation to the main axis. These control means include drive means attached to the chassis and mechanical transmission means ensuring the link between said drive means and said supports, so that the distance between the axes of the tools and the main axis is continuously adjustable by control of said fixed drive means. To allow continuous adjustment during machining of the radial positioning of the arms supporting the tools, while these arms are supported on a rotating plate, the device uses a first system which transforms a rotation of a fixed motor on the chassis into an axial translation of a rotating plate, connected to the tool support arms by a reversible screw-nut system which allows said axial translation to be transformed into a pivoting of the arms. The first transformation of the rotation of the motor into axial translation is done either by a rack-pinion system, or by a screw-nut system. This device thus allows a continuous variation of the radial positions of the tools to be ensured during the use of the device and, therefore, during the rotation of the plate, without the need to use for this a drive unit placed onboard the plate for this purpose.

One of the advantages of this device is that it allows the machining of revolving parts, according to the definition which was given at the start of this description, from long bars of substantially square or rectangular section, by tools rotating with an epicycloidal type movement around said bar and this by a device not requiring the use of motors onboard the rotating elements. Therefore, the rotating assembly is globally compact to minimize the centrifugal forces and thus reduce the weights of the structures in rotation, their costs and the energy needs required for their rotation. A drive unit located principally on the outside of the rotating structure allows the structure to be lightened and, notably, in the case of high rotational speeds of the rotating plate, to reduce any unwanted vibrations.

However, the mechanisms continually ensuring the radial positioning of the tools by the control of a fixed motor on the chassis, are mechanically complex, requiring a double conversion of rotational movement into translation movement then of this translation movement again into a rotational movement to pivot the tool support arms.

### SUMMARY

The aim of the present invention is therefore to propose a new system to continually ensure the radial positioning of the tools during the rotation of the plate which is simpler to manufacture, is more reliable and requires less moving mechanical elements.

With these targets in mind, the subject of the invention is a process for producing parts, notably elongated revolving parts of variable section in the longitudinal direction, by machining a bar held fixed in rotation, wherein a chassis is moved in relation to said bar, or conversely, along a main direction corresponding to the longitudinal direction of the bar, and the bar is machined, according to a required longitudinal and circumferential profile, by rotating tools carried by a main plate driven in rotation on the chassis in a plane transversal to said axial direction, the tools being attached to the plate by tool supports moving radially on this plate and according to said required profile, a radial movement of the tool supports is controlled according to the axial position of the bar in relation to the chassis and according to the circumferential position of the tools in relation to the bar.

According to the invention, the process is characterized in that, to control said radial movement, a secondary plate is driven in rotation, coaxially to the main plate, the secondary plate including means for actuating tool supports, said means being arranged so that the positions of the tool supports are in relation to the relative angular position between the main plate and the secondary plate and, to permanently adjust the radial positioning of the tools during the rotation of the plate, said relative angular position is modified.

In stationary state, the two plates are fixed in relation to each other and the radial positions of the tools remain fixed to execute the machining of the cylindrical portions of the part. To modify this radial position during the rotation of the plates, it suffices to temporarily modify the speed of one of the plates and, therefore, the rotational speed ratio of the two plates, which induces an angular offset between these and, therefore, the variation in the radial positions of the tools.

Thus, to continually adapt, during machining, the positions of the tools in relation to the required lengthwise profile of the part, it suffices to temporarily vary the speed of the secondary plate, in acceleration or in deceleration, in relation to that of the main plate, to modify the angular offset between the plates. The plates are designed, as will be seen below, so that the radial positions of the tool supports and, therefore, of the tools themselves, depend on this angular offset between the plates.

According to a first embodiment, each plate has its own rotational drive motor and the modification of the relative angular positions of the plates is done by a speed variation control of at least one of the motors, for example, by electronic speed control means, which allow very rapid and very precise speed variations to be ensured. For this purpose, a computer controlling the motors according to an adapted program, predetermined according to the required shapes of the circumferential and longitudinal profiles can notably be used.

According to a second embodiment, the modification of the relative angular positions of the plates is done by mechanical control means varying the length of the tight strand of a belt or chain transmission used to transmit the rotation of a motor to at least one of the plates, more particularly the secondary plate. According to a particularly advantageous arrangement, a single motor is used to drive the two plates by different belts and the length of the tight strand of one of the belts is varied by means of a tensioner pulley, the position of which can be controlled by a jack or any other adapted actuator.

According to yet another embodiment, the modification of the relative angular positions of the plates is done by a dedicated motor mounted between a drive element of the main plate and the secondary plate.

The subject of the invention is also a device, intended to implement the process described above, which includes means for the translation movement of a chassis in relation to the bar, or vice versa, along a main direction corresponding to the longitudinal direction of the bar and a rotating assembly driven in rotation in relation to the chassis along a main axis, the rotating assembly including a main plate and at least two rotating tools supported by movable supports guided in relation to the plate in a plane orthogonal to the main axis and the device including positional control means of the supports to adjust the radial positioning of the tools in relation to the main axis.

According to the invention, the device is characterized in that said positional control means of the tool supports include:
a secondary plate including means for actuating the tool supports arranged so that the positions of the tool supports are in relation to the relative angular position between the main plate and the secondary plate and
control means for said relative angular position, arranged so that said relative angular position can be varied during the rotation of the plates.

According to a particular arrangement, said actuating means include main cams and the tool supports are connected to main fingers applied to said cams. The cams have a shape such that their radii increase over a predetermined angle corresponding to the maximum angular offset between the plates and the amplitude of the variation in the radius is determined so as to generate a radial movement of the tools of a maximum amplitude required.

Preferentially, the tool supports are arms pivotally mounted on the main plate and connected in rotation to the fingers bearing on the cams.

Preferentially again, each main finger consists of an end of a lever pivotally connected to a tool support arm, the opposite end of the lever comprising a secondary finger bearing on a secondary cam associated with the main cam on which the main finger is in contact, the shapes and dimensions of the main and secondary cams and those of the lever being determined in such a way that the secondary finger is in contact with the secondary cam when the main finger is in contact with the main cam whatever the position of the contact point on the cam.

Following a variation in the relative angular position between the plates, the main finger is moved on the main cam and thus induces the pivoting of the tool support arm. More precisely, when the relative angular position between the plates varies in the direction causing the main finger to move on the cam to a position where the radius increases, the tool is moved towards the axis of the rotating assembly. Consequently, it is the main cam which supports the bearing force of the main finger corresponding to the plunging force of the tool during the machining. The secondary cam and finger ensure the radial movement of the tool in the opposite direction, that is towards the exterior, when the relative angular position of the plates is varied in the opposite direction, the main finger moving on the main cam towards a position where the radius decreases. The secondary finger and cam also ensure that the play between the fingers and the cams is taken up; for this purpose, the secondary finger is elastically mounted on the end of the lever, for example by means of a pivoting rod and a return spring between the lever and said rod. Although it is the secondary fingers which ensure the radial movement of the tools in the direction away from the main axis, it is the contact of the main fingers on the main cams which determines the radial positions of said tools. The fingers will be advantageously made in the form of rollers rotationally mounted on the lever.

The rotational drive of the tools is preferentially ensured by a motor fixed on the chassis and transmitting its rotation by means of a rotating ring, which drives in turn two-groove pulleys by means of a belt, the pulleys being rotationally mounted on the pivoting axis of the tool support arms, each of the said pulleys rotationally driving a tool by another belt extending along the tool support arm.

Preferentially, the plates are rotationally driven by one or more motors to which they are connected by pulleys and notched belts or chains to avoid all slipping of these transmission means between motors and plates.

According to a first embodiment, each plate has its own motor and motor speed adjustment means are provided so that the speed of at least one of the motors can be varied momentarily to generate a variation in the angular offset between the plates.

According to a second embodiment, one of the plates, preferably the secondary plate carrying the cams, is rotationally driven by a belt passing over a first idler pulley movable in translation on which the tight strand of the belt passes, that is the strand transmitting the rotational force, said first pulley being movable so that the length of the tight strand can be varied. A variation in the length of this tight strand during the rotational drive, at constant speed of the motor, generates a temporary variation in the speed of the driven plate and, therefore, a relative angular offset in relation to its previous position, this offset allowing the relative angular offset between the plates to be created when, for example, the other plate is maintained at constant rotational speed.

Preferentially then, the two plates are driven by the same motor, connected by a nonslip belt to the main plate and which therefore gives the rotational speed of the rotating assembly and the secondary plate is connected to the same motor by a belt passing over the first idler pulley. To generate the angular offset between the two plates, it suffices therefore to move the idler pulley, for example by means of an actuator controlled according to the profile of the required machined part. To compensate for the variations in the length of the tight strand during the movement of the first idler pulley, a second idler pulley acting as tensioner is mounted on the free strand of the belt.

According to yet another embodiment, the device includes drive means to rotationally drive the two plates by a same main motor, said drive means including an ancillary motor mounted between the main motor and the secondary plate and ancillary motor control means to generate a variation in the angular offset between the plates. The ancillary motor has, for example, its shaft rotationally attached with a drive shaft of the main motor and its stator attached to the secondary plate by a notched belt. When the shaft of the ancillary motor is rotationally stationary in relation to its stator, the two plates are rotationally fixed in relation to each other. To obtain an angular offset between the plates, it suffices to control the ancillary motor to induce a relative rotation between its rotor and its stator. The ancillary motor can be a step motor or any other onboard drive component on a drive shaft of the main plate and capable of, alternatively, rotationally connecting this drive shaft with the secondary plate or of creating a controlled angular offset between them.

Other features and advantages of a machine in compliance with the invention and its use will become apparent on reading the following description.

### BRIEF DESCRIPTION OF THE DRAWINGS

Refer to the appended drawings where:

FIG. 1 represents a machining machine equipped with a device in compliance with the invention,

FIG. 2 is a simplified representation in particular showing the rotational drive of the tools,

FIG. 3 shows the arrangement of the motors on the chassis of the device,

FIG. 4a is a perspective view showing the rotating assembly with the two plates, the tool support arms not being represented,

FIG. 4b is a perspective view similar to that of FIG. 4a but with the main plate removed in addition so that the cam and lever system controlling the pivoting of the tool support arms can be more clearly seen,

FIG. 5 is a schematic view illustrating the principle of the second embodiment,

FIG. 6 is a schematic view illustrating the principle of the third embodiment.

### DETAILED DESCRIPTION

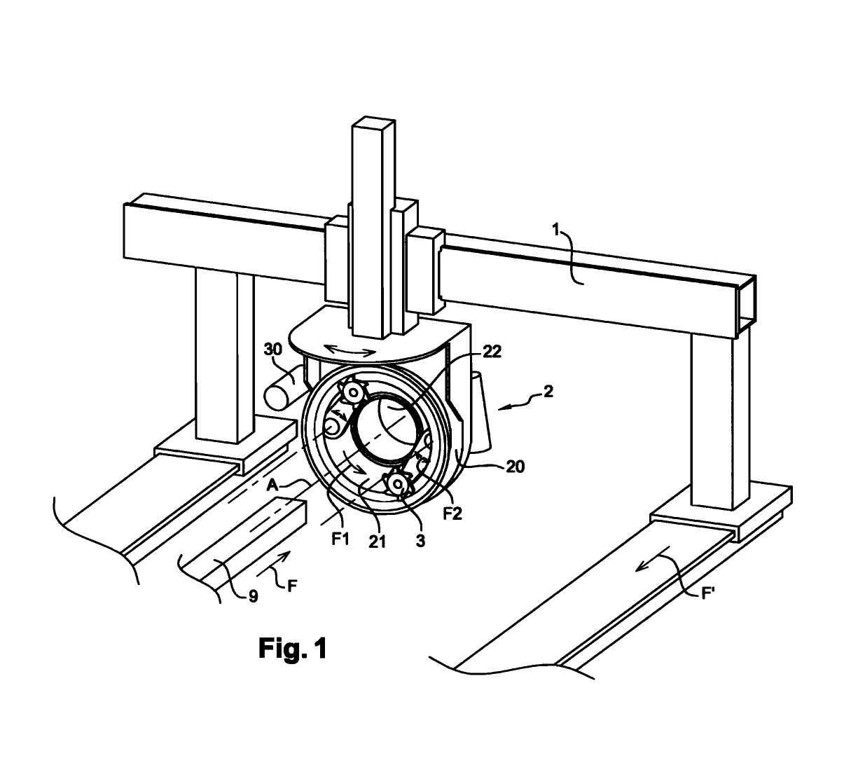

The machining machine shown on FIG. 1 includes a gantry frame 1 on which the machining device 2 is installed. This device includes a chassis 20 on which a rotating assembly 21 is installed. This assembly is comprising a bore 22 through which the machined part 9 passes during its machining.

For further details on the principle of machining elongated revolving parts of variable section in the longitudinal direction, by machining of a bar fixed in rotation, refer to the above-mentioned document WO2010/046570.

It is simply briefly recalled here that the rotating assembly 21 carries machining tools 3 driven in rotation and radially mobile so that the distance between the rotational axis of the rotating assembly and the tools can be modified during the rotation of said rotating assembly. Thus, the section of the machined part 9 can be varied when it is moved relatively in relation to the gantry frame along the direction shown by arrow F, oriented substantially along the main rotational axis A of the rotating assembly. It can be noted that the part can be moved in relation to the gantry frame remaining fixed, or the gantry frame moved, in the direction shown by arrow F′, in relation to the part held fixed. The main rotational axis A can be oriented in the longitudinal direction of part 9 or obliquely in relation to this direction.

The rotating assembly 21 includes a main plate 5 driven in rotation in the direction shown by arrow F1. To ensure the radial movement of the tools 3, these are installed on arms 4 which are themselves pivotally mounted on the main plate 5 along axes B parallel to the main axis A so that they can pivot in the direction shown by arrow F2 in a plane perpendicular to axis A. For this, each arm 4 is attached to a shaft 41 guided in rotation along axis B in a bearing 54 of plate 5. The main plate 5 is driven in rotation by a motor 50 on the shaft of which a pulley 51 connected to plate 5 by a belt 52 is mounted.

A secondary plate 6 is rotationally mounted, also along the main axis A, between the main plate and the chassis 20. The secondary plate 6 is driven by a motor 60, a pulley 61 and a belt 62. The secondary plate 6 includes two cam assemblies 7, symmetrical in relation to axis A, on which the fingers bear. These fingers consist of rollers 43, 44 carried by the respective ends of levers 42 pivoting around axes B and attached to shafts 41. The levers 42 are therefore attached to the arms 4 pivoting around axes B. One of the rollers 43 is mounted at the end of a rigid arm 421 of the lever 42; the other roller 44 is mounted on a pivoting arm 422 of the lever 42.

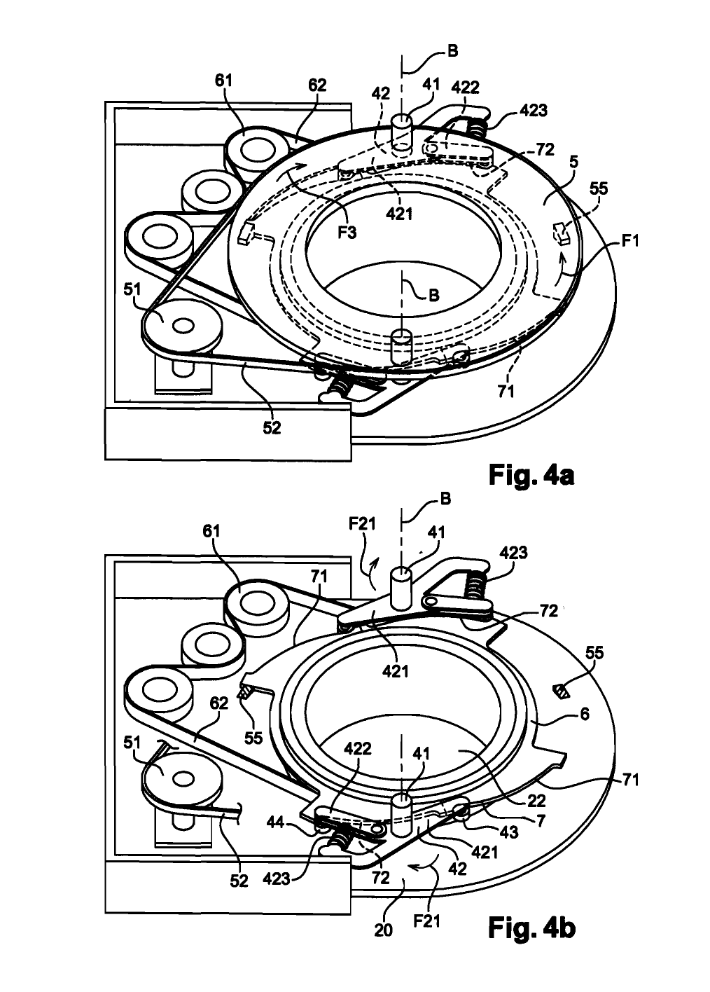

Each cam assembly 7 includes a main cam 71 and a secondary cam 72. The main cam 71 is arranged so that, when the secondary plate 6 rotates in relation to the main plate 5 in the direction shown by arrow F3 (see FIG. 4), the cam 71 pushes the roller 43, mounted on the rigid arm 421 of lever 42, radially towards the exterior, so as to pivot the lever, and therefore the arms 4, in the direction shown by arrow F21, direction which moreover corresponds to moving the tool 3 closer to the main axis A. Cam 72 has a profile the radius of which varies inversely to that of the main cam 71 so that, when the secondary plate 6 carrying the cams 7 rotates in relation to the main plate 5 carrying the levers, the roller 44 rolling on the cam 72 holds the roller 43 in contact with the cam 71. Thus, when the secondary plate 6 rotates in relation to the main plate 5 in the direction opposite to that shown by arrow F3, the cam 72 pushes the roller 44, mounted on the pivoting arm 422 of lever 42, radially towards the exterior, so that the lever and, therefore, the arms 4 pivot in the direction opposite to that shown by arrow F21, direction which moreover corresponds to the moving of tool 3 away from the main axis A. Also, the arm 422 which is pivotally mounted on the lever 42 is also connected to said lever 42 by a spring 423 so as to ensure that the two rollers, 43 and 44, are always in contact with the respective cams 71, 72 and thus guarantee that there is, at no time, play between the levers and the cams liable to leave a pivoting freedom to the tool holder arm 4. Consequently, tool 3 is always accurately positioned in relation to the position of the roller 43 on the main cam 71 and, therefore, in relation to the relative angular positions of the two plates 5 and 6.

Thus, on account of the rotational direction Fl of the rotating assembly 21 and, therefore, of the two plates 5 and 6, if the secondary plate 6 which carries the cams is temporarily slowed down, a relative angular offset is created between the two plates in the direction shown by arrow F3, inducing therefore a pivoting of the levers 42 and of the arms 4 in the direction shown by arrows F21 and a movement of the tool 3 towards the axis A and, therefore, a reduction in the radius of the machined part. Conversely, if the secondary plate 6 is momentarily accelerated when the rotational speed of the main plate 5 remains fixed, the levers 42 and the arms 4 will pivot in the direction opposite to that of arrow F21 leading to an increase in the radius of the machined part. Therefore, it can be understood that by simply controlling the rotational speeds of motors 50 and/or 60, the machining radius can be rapidly varied and, therefore, not only machine a part with any lengthwise profile, within the limits of course of the maximum travel of the tools, but also machine a part with a radius variable in a same section orthogonal to the main axis. This possibility in particular allows the machining of parts of polygonal section, notably square or rectangular, of oval section, and parts of helicoidal shape for example, or, generally, all parts the envelope, that is the solid form, of which is defined by a transverse section the shape and area of which can vary in the longitudinal direction of the part.

The speed control of motors 50 and 60 can be of any type adapted to ensure the highest possible accuracy in the variations of the relative speeds, in particular by electronic control.

For safety reasons, to avoid all risks of too high a relative angular offset between the plates, stops 55 are attached to the main plate in order to block the movement of the cams. Although FIG. 4b does not show plate 5, stops 55 are represented to illustrate their function which limits the pivoting of the plate 6 in relation to the plate 5.

The rotational drive of the tools 3 is done in the following manner:

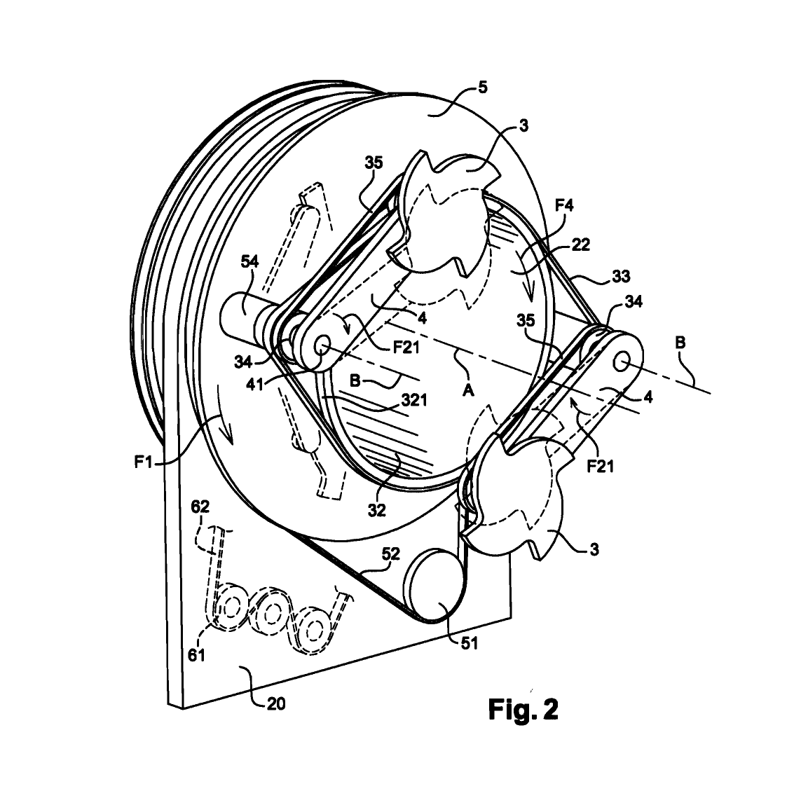

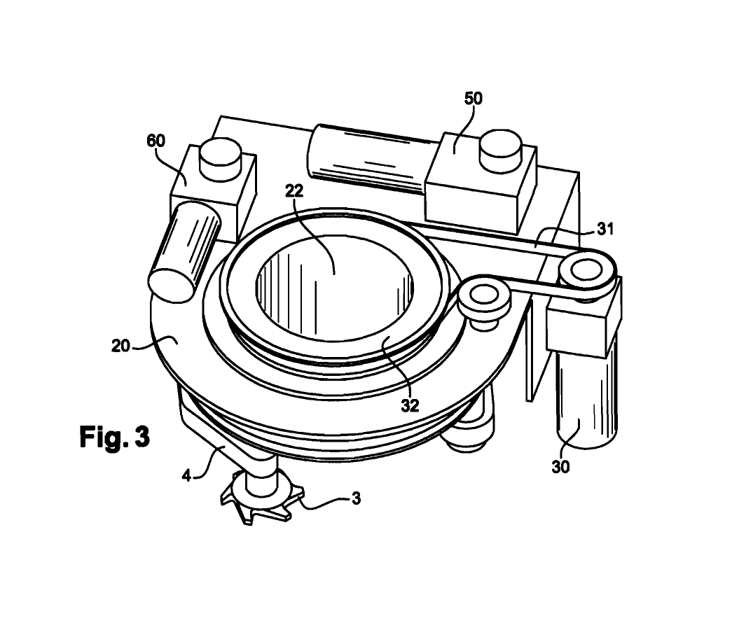

On the rear side of the device, that is on the side opposite from the one where the tools are found, and visible on FIG. 3, a motor 30 drives in rotation, by a notched belt 31, an inner ring 32 rotating around the main axis A, the inner cylindrical wall of which defines the bore 22 allowing the machined part to pass through it. The front end of the ring 32 includes a notched pulley groove 321 which accommodates a notched belt 33 passing over one of the grooves of two two-groove pulleys 34 rotationally mounted on the shafts 41 of pivoting axes B of the arms 4 as can be seen on FIG. 2. The two grooves of the pulleys 34 are connected to the tools 3 by a belt 35. Thus, independently of the rotation of the rotating assembly 2 and of the positions of the arms 4, the tools 3 are driven in rotation by the motor 30 mounted in fixed position on the chassis 20, and their rotational speeds can be adjusted directly by a speed regulator of motor 30. Note, however, that a part of the rotational drive of the tools results directly from the rotational drive of the plates. Indeed, if the motor 30, and therefore the inner ring 32, are immobilized in rotation, the rotation of the plate 5 induces a rotation of the two-groove pulleys 34 on their axes

B and, therefore, a rotation of the tools. In fact, the motor allows, by a rotational drive of the ring 32 in the direction opposite (arrow F4) to the rotation of plate 5, as is shown on FIG. 2, an increase in the rotational speed of the tools which would result from the rotation of plate 5 alone, and the motor 20 also allows the effective rotational speed of the tools to be adjusted, independently of that of the plate.

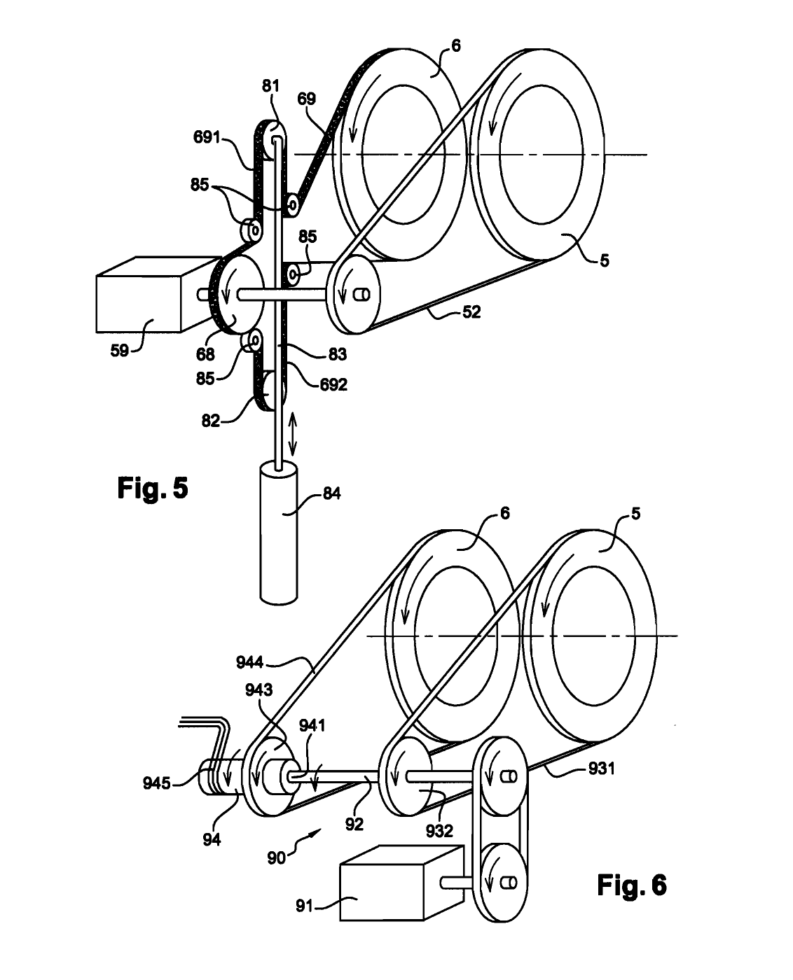

FIG. 5 schematically represents another embodiment allowing the relative angular offset of plates 5 and 6 to be controlled. In this case, the main plate 5 is driven in rotation directly by a motor 59 carrying a drive pulley 51, via the belt 52. The shaft of the motor 59 carries a second pulley 68, driving in rotation the secondary plate 6 via the belt 69. The drive reduction ratios of the driving of the two plates are the same to ensure, in steady state, the same rotational speed of the two plates. The drive belt 69 of the secondary plate 6 passes over a set of idler pulleys notably including two pulleys 81, 82 rotationally mounted on a same slide 83 the sliding, transversal to the general running direction of belt 69, of which is controlled by an actuator 84. The other pulleys 85 are fixed. The movement of the pulley 81 located on the tight strand 691 of the belt 69 induces a variation in the length of this tight strand and therefore an angular offset between the two plates. The variation in the length of the tight strand is compensated for by an opposite variation in length of the free strand 692, authorized and controlled by the movement of the pulley 82, simultaneously with that of the pulley 81, the pulley 82 acting therefore in the manner of a belt tensioner to compensate for the variations in the length of the tight strand.

FIG. 6 schematically represents yet another embodiment allowing the relative angular offset of the plates 5 and 6 to be controlled. In this case, the device includes drive means 90 to drive in rotation the two plates 5, 6 by a same main motor 91, via a main drive shaft 92. The main plate 5 is driven from this main shaft by a nonslip link, for example by a notched belt 931 passing over a pulley 932 attached to the shaft 92. The rotational speed of the plate 5 can therefore be adjusted by adjusting the speed of the motor 91.

The secondary plate 6 is driven from this main shaft 92 by means of an onboard ancillary motor 94 the rotor 941 of which is connected in rotation to the shaft 92. The stator box 942 of the motor 94 carries a pulley 943 which drives the secondary plate 6 by a nonslip link, for example by notched belt 944. The ratio of the diameters of the pulley 932 and of the plate 5 is the same as that of the pulley 941 and of the plate 6 in such a way that the two plates 5 and 6 rotate at the same angular speed if the pulleys 932 and 943 also rotate at the same speed.

The motor 94 is supplied by a regulator via a rotating electrical collector 945 allowing accurate control of the speed and the angular position between rotor and stator. In stable state, without variation of the machining radius, the motor 90 is not supplied and its stator and its rotor are fixed in relative rotation. The two plates 5 and 6 are driven therefore exactly at the same speed. To command a variation in the machining radius, it suffices to command a rotation of the motor 94 which will induce an angular offset of the plates 5 and 6 and, therefore, a pivoting of the tool-holder arms as described previously.

Also, in an equivalent manner, the stator of the ancillary motor 94 can be connected to the main drive shaft 92, and the rotor to the pulley 943. Also, the motor 94 can be replaced by any other equivalent control means allowing an angular offset to be generated between the main drive shaft 92 and the pulley 943.

The invention is not limited to the examples described above and includes all variants in the systems allowing a controlled relative angular offset to be ensured between the two plates 5 and 6 during their rotation. Also, the tool rotational drive system can be modified. In particular, it will be possible to ensure the rotation of the tools by motors onboard the plate 5 or on the arms 4.

The tool-holder arms can also be curved, with a concavity oriented towards the main axis, in order to avoid all risks of contact between the arm and the machined part, for example at corners when machining parts with a square or rectangular section. Also, one or more of the intermediary idler pulleys can be used to ensure the transmission of the rotational movement from the pulley 34 mounted on the pivoting axis of the arms to the rotating tool so that the belt 35 follows the curvature of the arm and/or to vary the speed ratio between the pulley 34 and the tool 3.

The arms 4 can also be made in two parts, adjustable in angular position in relation to each other, for example along axis B, to allow a fine adjustment, with an accuracy of 0.05 mm, of the radial position, in relation to axis A, of each tool, independently of each other. This allows equal spacing of the tools to be ensured in relation to the main axis of the machine and therefore allows accurate and identical machining by the two tools.

1-15. (canceled)

16. A process for producing elongated revolving parts of variable section in a longitudinal direction, comprising machining a bar held fixed in rotation, moving a chassis relatively in relation to said bar, or along a main direction corresponding to a longitudinal direction of the bar, and machining the bar, according to a required longitudinal and circumferential profile, by rotating tools carried by a main plate driven in rotation on the chassis, the tools being connected to the plate by tool supports radially mobile on the plate and, according to the required profile, controlling radial movement of the tool supports according to the axial position of the bar in relation to the chassis and according to the circumferential position of the tools in relation to the bar, and
driving a secondary plate in rotation coaxially to the main plate to control said radial movement, the secondary plate including means for actuating the tool supports, arranged so that the positions of the tool supports depend on the relative angular position between the main plate and the secondary plate and, to permanently adjust the radial positioning of the tools during the rotation of the main plate, modifying said relative angular position.

17. The process according to claim 16, further comprising each said plate having its own rotational drive motor and the modifying step comprises modifying the relative angular positions of the plates by a speed variation control of at least one of the motors.

18. The process according to claim 16, further comprising the modifying step comprising the modifying of the relative angular positions of the plates by mechanical control means varying a length of a tight strand of a transmission by belt or chain used to transmit the rotation of a motor to at least one of the plates.

19. The process according to claim 16, further comprising the modifying step comprising modifying the relative angular positions of the plates by a dedicated motor mounted between a drive element of the main plate and the secondary plate.

20. A device for producing elongated revolving parts of variable section in the longitudinal direction, by machining of a bar held fixed in rotation, including means for translation movement of a chassis in relation to the bar, or in a main direction corresponding to a longitudinal direction of the bar, a rotating assembly driven in rotation in relation to the chassis around a main axis, the rotating assembly including a main plate and at least two rotating tools supported by mobile supports guided in relation to the main plate in a plane orthogonal to the main axis, and positional control means for the supports to adjust radial positioning of the tools in relation to the main axis, said positional control means of the supports including a secondary plate including means for actuating the tool supports, arranged so that the positions of the tool supports depend on the relative angular position between the main plate and the secondary plate and
means for controlling said relative angular position arranged so that said relative angular position can be varied during the rotation of the plates.

21. The device according to claim 20, wherein said actuating means include main cams and the tool supports are connected to main fingers applied to said main cams.

22. The device according to claim 21, wherein the tool supports are arms pivotally mounted on the main plate and rotationally connected to the fingers bearing on the main cams.

23. The device according to claim 22, wherein each said main finger consists of an end of a lever pivotally connected to a tool support arm.

24. The device according to claim 23, wherein the end of the lever opposite the main finger comprises a secondary finger bearing on a secondary cam associated with one of the main cams, shapes and dimensions of the main and secondary cams and of the lever being determined so that the secondary finger is in contact with the secondary cam when the main finger is in contact with said one of the main cams, irrespective of the position of the contact point of the main finger on the one of the main cams.

25. The device according to claim 24, wherein the secondary finger is elastically mounted on the end of the lever.

26. The device according to claim 22, wherein the rotational drive of the tools is ensured by a fixed motor on the chassis and transmitting its rotation by means of a rotating ring, driving in turn, by a belt, pulleys with two grooves rotationally mounted on the pivoting axes of the tool support arms, each of said pulleys driving in rotation a tool by another belt extending along the tool support arm.

27. The device according to claim 16, wherein each said plate has its own motor and motor speed adjustment means are provided so that a speed of at least one of the motors can be momentarily varied to generate a variation in the angular offset between the plates.

28. The device according to claim 16, wherein one of the plates is driven in rotation by a belt passing over a first idler pulley mobile in translation on which a tight strand of a belt passes, said first idler pulley being movable in a manner to vary a length of the tight strand to generate a variation in the angular offset between the plates.

29. The device according to claim 28, wherein the two plates are driven by the same motor, connected by a nonslip belt to the main plate and the secondary plate is connected to the same motor by a belt passing over the first idler pulley.

30. The device according to claim 16, further comprising drive means for driving in rotation the two plates by a same main motor, said drive means including an ancillary motor mounted between the main motor and the secondary plate and ancillary motor control means for generating a variation in the angular offset between the plates.
